(19) United States
(12) Patent Application Publication
(10) Pub. No.: US 2022/0340496 A1
(43) Pub. Date: Oct. 27, 2022

(54) PROCESS FOR PRODUCING VARIANTS OF CONCRETE EXPOSED AGGREGATE FINISH

(71) Applicant: Ralph Richard Martin, Gallipolis, OH (US)

(72) Inventor: Ralph Richard Martin, Gallipolis, OH (US)

(21) Appl. No.: 17/728,918

(22) Filed: Apr. 25, 2022

Related U.S. Application Data
(60) Provisional application No. 63/178,584, filed on Apr. 23, 2021.

(51) Int. Cl. C04B 40/00; C04B 14/06; C04B 14/22; C04B 28/02

(52) U.S. Cl. CPC C04B 40/0042; C04B 14/06; C04B 14/22; C04B 28/02

(57) ABSTRACT

The application generally relates to a process for producing variants of concrete exposed aggregate finish (EAF) based on selected ratios from local and import, fine and coarse aggregate components. In particular, the process allows a user to select the desired appearance of the end result exposed aggregate finish, by selecting a ratio of local vs import fine aggregate and/or a ratio of local vs import coarse aggregate. Thus, the process allows for the ability to create a spectrum of daily variations of overall concrete mixes in order to achieve daily end result exposed aggregate finish.

### FIELD OF THE DISCLOSURE

The application relates in general to a process for producing variations of exposed aggregate finish (EAF) of concrete surfaces.

### BACKGROUND

Concrete is a composite material, comprising a matrix of coarse aggregate (typically a stone/gravel mixture), fine aggregate (typically sand), and a binder (typically Portland cement) that hardens (cures) over time. Many types of concrete are available, determined by the formulations of binders and the types of aggregate used to suit the application for the material. These variables determine physical properties such as strength and density, as well as chemical and thermal resistance of the finished product.

Aggregate contains a coarse gravel or crushed rocks such as limestone or granite, and a fine aggregate such as sand.

Cement is the most prevalent kind of concrete binder. For cementitious binders, water is mixed with the dry powder and aggregates which produces a semi-liquid slurry that can be shaped, typically by pouring it into a form. The concrete solidifies and hardens through a chemical process called hydration. The water reacts with the cement, which bonds the other components together, creating a robust, stone-like material. Other cementitious materials, such as fly ash and slag cement, are sometimes added—either pre-blended with the cement or directly as a concrete component—and become a part of the binder for the aggregate. Fly ash and slag can enhance some properties of concrete such as workability and durability.

Admixtures are added to modify the cure rate or properties of the material. Mineral admixtures use recycled materials as concrete ingredients. Conspicuous materials include fly ash, a by-product of coal-fired power plants; ground granulated blast furnace slag, a byproduct of steelmaking; and silica fume, a byproduct of industrial electric arc furnaces.

Fine and coarse aggregates make up the bulk of a concrete mixture. Sand, natural gravel, and crushed rock are used mainly for this purpose. Recycled aggregates (from construction, demolition, and excavation waste) are increasingly used as partial replacements for natural aggregates, while a number of manufactured aggregates, including air-cooled blast furnace slag and bottom ash are also permitted.

Decorative stones such as quartzite, small river stones or crushed glass are sometimes added to the surface of concrete for a decorative “exposed aggregate” finish, popular among landscape designers and countertop manufacturers.

Conventional concrete, regardless of use or application, requires at a minimum one fine aggregate (sand), one coarse aggregate (gravel), cement and water to produce or manufacture usable concrete. If aggregate quantities and source locations do not vary and cement suppliers remain constant, pouring conventional concrete mixes daily would produce an exposed aggregate finish (“EAF”) with minimal visual variations. The EAF's would differ slightly in grain structure arrangement and color but the overall appearance would not. This is due to the use of one fine and one coarse aggregate. Mixes could be designed featuring heavy coarse or heavy fine aggregate contributions, but exposure of the aggregate's surface will only reveal what's known, more or less sand or gravel.

Accordingly, there is a need for a process for producing daily variations of EAF.

### SUMMARY

The present disclosure generally provides a process for producing variants of concrete exposed aggregate finish (EAF) based on selected ratios from local and import, fine and coarse aggregate components. In particular, the process allows a user to select the desired appearance of the end result exposed aggregate finish, by selecting a ratio of local vs import fine aggregate and/or a ratio of local vs import coarse aggregate. Thus, the process allows for the ability to create a spectrum of daily variations of overall concrete mixes in order to achieve daily end result exposed aggregate finish.

In a version of the application, the process for producing variants of concrete exposed aggregate finish may comprise the steps of: selecting a local fine aggregate; selecting an import fine aggregate; determining a first mix ratio between the local fine aggregate and the import fine aggregate; selecting a local coarse aggregate; selecting an import coarse aggregate; determining a second mix ratio between the local coarse aggregate and the import coarse aggregate; producing an overall composite fine aggregate by mixing the local fine aggregate with the import fine aggregate in accordance with the first mix ratio; producing an overall composite coarse aggregate by mixing the local coarse aggregate with the import coarse aggregate in accordance with the second mix ratio; determining a third mix ratio between the overall composite fine aggregate and the overall composite coarse aggregate; producing a final concrete mixture by mixing the overall composite fine aggregate with the overall composite coarse aggregate in accordance with the third mix ratio; producing a cured concrete product by utilizing the final concrete mixture; and producing an exposed aggregate finish of the cured concrete.

These and other features of the present application will become readily apparent upon further review of the following specification and drawings.

### BRIEF DESCRIPTION OF THE DRAWINGS

For a more complete understanding of this disclosure, reference is now made to the following description, taken in conjunction with the accompanying drawings, in which:

FIG. 1 is a flowchart of an example process for producing variants of exposed aggregate finish;

FIG. 2 is a flowchart of an example process for producing variants of exposed aggregate finish;

FIG. 3 is a chart for assisting in the selection element ratios utilized in the process for producing variants of exposed aggregate finish; and

FIG. 4 is a chart for assisting in the selection of colored glass utilized as an additive in an embodiment for producing variants of exposed aggregate finish.

### DETAILED DESCRIPTION

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other versions that depart from these specific details. In other instances, detailed descriptions of well-known devices, circuits, and methods are omitted so as not to obscure the description of the present invention with unnecessary detail.

Unless otherwise defined, all technical terms used herein have the same meaning as commonly understood by one of ordinary skill in the art to which the invention belongs. As used in the specification and the appended claims, the singular forms “a,” “an,” and “the” include plural references unless the context clearly dictates otherwise. Any reference to “or” herein is intended to encompass “and/or” unless otherwise stated.

Although the present disclosure and its advantages have been described in detail, it should be understood that various changes, substitutions and alterations can be made herein without departing from the spirit and scope of the disclosure as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

The application generally relates to a process 100 for producing variants of concrete exposed aggregate finish (EAF) based on selected ratios from local and import, fine and coarse aggregate components. In particular, the process 100 allows a user to select the desired appearance of the end result exposed aggregate finish, by selecting a ratio of local vs import fine aggregate and/or a ratio of local vs import coarse aggregate. Thus, the process 100 allows for the ability to create a spectrum of daily variations of overall concrete mixes in order to achieve daily end result exposed aggregate finish.

The example process 100 involves that at least one component of an import fine aggregate or at least one component of an import coarse aggregate, or both, are provided in order to process the variant of end result EAF. Fine aggregates and coarse aggregates are typically classified depending on the size of the aggregate particles. For example, fine aggregate are particles that pass through a 4.75 mm sieve and retain on a 0.075 mm sieve. Fine aggregate may include river sand, machine sand, crushed stone sand, and crushed gravel sand. Whereas coarse aggregate are particles that retain on a 4.75 mm sieve. For example, some coarse aggregates are comprised of brick chips, stone chips, gravels, pebbles, clinkers, cinders, etc.

Typically, both fine and coarse aggregate is sourced geographically locally due to the weight of the components and the cost to transport. Thus, for example, if the concrete is made in Ohio, only local coarse and local fine aggregate is ascertained within the region in order to produce the concrete, resulting in a limited number of variants of EAF. By introducing an additional component of an import coarse aggregate or import fine aggregate or both, the ratio of each aggregate can be varied daily which results in a much broader spectrum of end result EAF.

For example, if in Ohio, both local fine and local coarse aggregate may be sourced from outwash deposits along the Ohio River. Sand and gravel are unconsolidated, natural accumulations of rounded rock and mineral fragments consisting of particles of limestone, dolomite, quartzite, sandstone, and others. Outwash deposits along the Ohio River were formed by glaciers from Canada which accounts for the wide range of chemical and mineralogical variations.

As an example of import fine aggregate, if located in the Ohio region, white coastal sand sourced from beaches outside of the Ohio region can be utilized as an import fine aggregate. The color of the sand grains is dictated by the source which is often pulverized dead coral. The slope of the beach and the wave energy will determine the size of grain. Further, if in the Ohio region, an example of import coarse aggregate may be Limestone sourced from Minnesota which is a carbonate sedimentary rock consisting mainly of calcite and aragonite and is commonly white to gray in color. Nearly a quarter of all sedimentary rock is limestone thus it's readily available as an import coarse aggregate. Thus, local aggregate is aggregate that is easily readily available and sourced within the local geographical area where the concrete is being made. Whereas, import aggregate is aggregate that is sourced from outside the local region where the concrete is being made and is not readily available

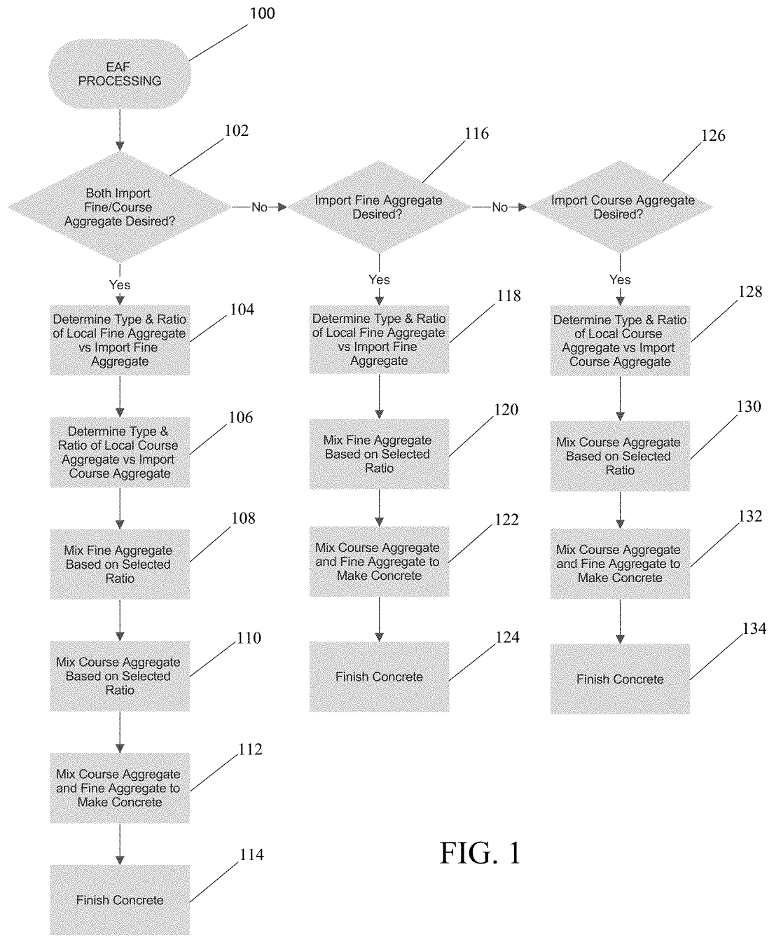

FIG. 1 is a first example flowchart embodying the principles of the process 100 for producing variants of exposed aggregate finish. In the first Step 102, it is determined whether an import fine aggregate, an import coarse aggregate, or both an import fine aggregate and an import coarse aggregate is/are utilized in the overall concrete mixture to produce a desired variant of EAF.

If both an import fine aggregate and an import coarse aggregate are desired, the process continues with Step 104. In step 104, the type of import fine aggregate is chosen and the ratio of local fine aggregate to import fine aggregate is chosen, which defines the makeup of the overall composite fine aggregate. In step 106, the type of import coarse aggregate is chosen and the ratio of local coarse aggregate to import coarse aggregate is chosen, which defines the makeup of the overall composite coarse aggregate.

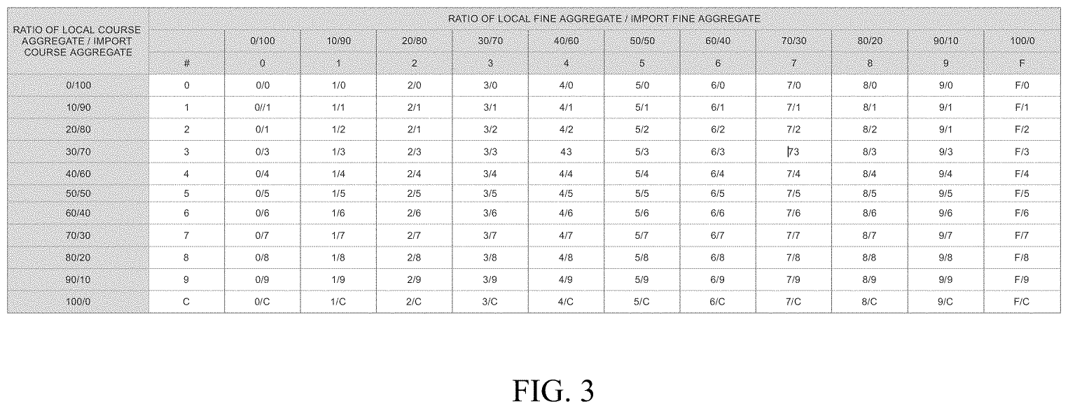

FIG. 3 is a chart for assisting in the selection of components utilized in the process for producing variants of exposed aggregate finish. The x-axis of the chart provides the spectrum of ratios, in increments of 10%, of local fine aggregate vs import fine aggregate based on the total amount of local fine aggregate and the import fine aggregate (overall composite fine aggregate). Thus, for example, column 7 may be selected in order to define the fine aggregate mix ratio as 70% local fine aggregate and 30% import fine aggregate, producing a unique end product EAF. The y-axis of the chart provides the spectrum of ratios, in increments of 10%, of local coarse aggregate vs import coarse aggregate based on the total amount of local coarse aggregate and the import coarse aggregate (overall composite coarse aggregate). Thus, for example, row 4 may be selected in order to define the coarse aggregate mix ratio as 40% local coarse aggregate and 60% import coarse aggregate, producing in combination with the overall composite fine aggregate a unique end product EAF as desired.

The chart as provided in FIG. 3 is an example as to how the respective fine aggregate and coarse aggregate import vs. local can be determined. In the example chart, increments of 10% are utilized producing a grid of 11×11, or 121 variations of end result EAF based on the option of two fine aggregate (local/import) and two coarse aggregate components (local/import). However, other fractions can certainly be utilized in order to determine number of options along the x-axis and y-axis, for example, 5% increments could be utilized which would provide a grid of 21×21, or 441 variations of end result EAF. In other terms, smaller increment ranges would provide a larger grid, thereby providing more options, each having a smaller variation in end product.

After the respective ratios have been selected, in Step 108, 110, the fine aggregate components are mixed to produce an amount of the overall composite fine aggregate and the coarse aggregate components are mixed to produce an amount of the overall composite coarse aggregate. The ratio of the amounts/quantities of the overall composite fine aggregate and the overall composite coarse aggregate can vary depending on desired results. Preferably, component ratios are mixed based on volume; however, components ratios may be mixed based on weight.

Thereafter, in Step 112, the overall composite fine aggregate and the overall composite coarse aggregate are combined together to form an amount of the final concrete mixture. Thereafter, the mixture is combined with cement, admixtures and additives as well as water and allowed to cure. Lastly, in Step 114, the concrete surface is revealed per customary polishing standards producing a unique exposed aggregate finish.

If only an import fine aggregate is desired, the process continues with Step 116 after Step 102. In step 118, the type of import fine aggregate and the ratio of local fine aggregate to import fine aggregate is chosen, which defines the overall composite fine aggregate.

With reference to FIG. 3, the mix ratio of the local fine aggregate to the import fine aggregate can be selected based on options provided in the x-axis in 10% increments. Thus, for example, column 3 may be selected in order to define the fine aggregate mix ratio at 30% local fine aggregate and 70% import fine aggregate, producing a unique end product EAF based solely on fine aggregate local/import ratios. The y-axis of the chart provides the spectrum of ratios of local coarse aggregate vs import coarse aggregate based on the total amount of local coarse aggregate and the import coarse aggregate. However, for this example, an import coarse aggregate was not elected and thus, by default, 100% of the overall composite coarse aggregate will be local coarse aggregate as defined in the row labeled C.

After the fine aggregate ratio has been selected, in Step 120, the fine aggregate components are mixed to produce the overall composite fine aggregate. A type of local coarse aggregate is determined which, in this case, defines 100% of the overall composite coarse aggregate.

Thereafter, in Step 122, the composite fine aggregate (Ratio of Local/Import) and the composite coarse aggregate (100% local) are combined together to form the final concrete mixture. Thereafter, the mixture is combined with cement admixtures and additives as well as water and allowed to cure. Lastly, in Step 124, the concrete surface is revealed per customary standards producing a unique exposed aggregate finish.

If only an import coarse aggregate is desired, the process continues with Step 126 after Step 102. In step 128, the type of import coarse aggregate and the ratio of local coarse aggregate to import coarse aggregate is chosen, which defines the overall composite coarse aggregate.

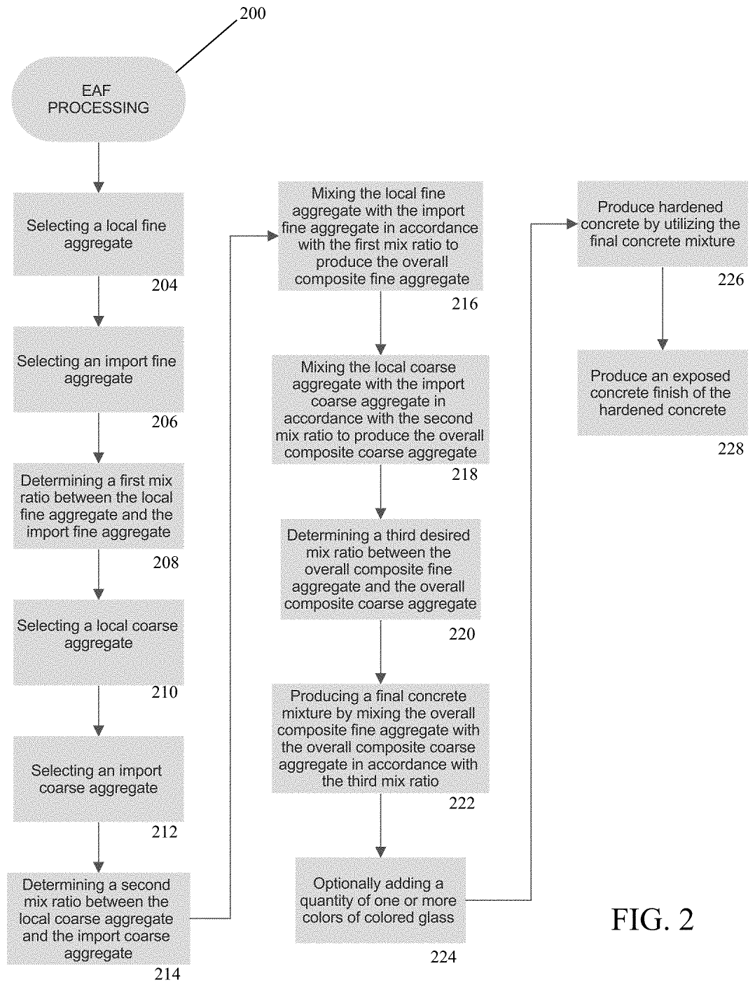

With reference to FIG. 2, the mix ratio of the local coarse aggregate to the import coarse aggregate can be selected based on options provided in the y-axis in 10% increments. Thus, for example, column 6 may be selected in order to define the coarse aggregate mix ratio as 60% local coarse aggregate and 40% import coarse aggregate, producing a unique end product EAF based solely on coarse aggregate local/import ratios. The x-axis of the chart provides the spectrum of ratios of local fine aggregate vs import fine aggregate based on the total amount of local fine aggregate and the import fine aggregate (overall composite fine aggregate). However, for this example, an import fine aggregate was not elected and thus, by default, 100% of the overall composite fine aggregate will be local fine aggregate as defined in the column labeled F.

After the coarse aggregate ratio has been selected, in Step 130, the coarse aggregate components are mixed to produce the overall composite coarse aggregate. Thereafter, a type of local fine aggregate is determined which, in this case, defines 100% of the overall composite fine aggregate.

Thereafter, in Step 132, the composite coarse aggregate (Ratio of Local/Import) and the composite fine aggregate (100% local) are combined together to form the final concrete mixture. Thereafter, the mixture is combined with cement admixtures and additives as well as water and allowed to cure. Lastly, in Step 134, the concrete surface is revealed per customary standards producing a unique exposed aggregate finish.

In certain embodiments of the application, to enhance the visual effects of the resulting EAF, colored glass pieces, fragments or chards can be introduced either as a singular color or in combination in varying quantities. For example, ten distinct colors of glass introduced individually would create an additional ten combination possibilities per selected final concrete mixture. The amount of each elected colored glass can be varied in order to achieve a desired appearance. The glass can be electively applied in any application, usage or situation but fragment or chard size, color, dosing rates, etc. must be determined prior through design and testing.

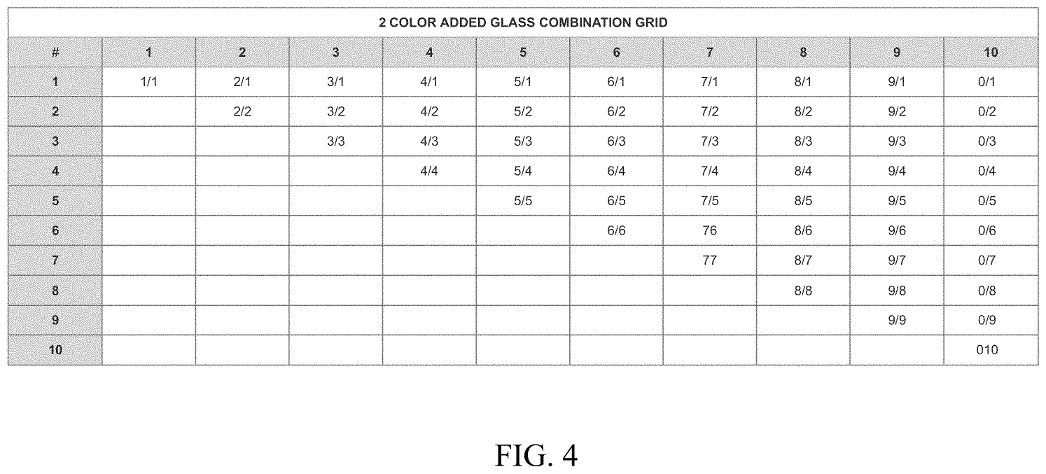

With reference to FIG. 4, each of the example ten glass colors are designated with a single digit 1-9 and 10 is represented by 0. Additional glass colors number more than 10 will be designated with letters, beginning with A and continuing sequentially. Combining the mix ID number from the concrete mix design chart with the possible two glass combination numbers shown in the glass chart reveals a 4, 5, 6 or more digit mix code of numbers and letters, which identifies completely the significant components of the mix. Overall, the ratio of the local and imported aggregates and the identification of the glass shard components are major factors in determining the overall appearance of the EAF.

FIG. 2 is a second example flowchart 200 embodying the principles of the process for producing variants of exposed aggregate finish which includes both an import fine aggregate and an import coarse aggregate. The process 200 allows for the ability to create a spectrum of daily variations of overall concrete mixes in order to achieve daily end result exposed aggregate finish.

In the first Step 204, a local fine aggregate is selected, for example, either naturally occurring sand or mechanically crushed sand sourced geographically locally where the concrete is being made.

In step 206, an import fine aggregate is selected, for example, a coastal sand that is sourced outside of the local region where the concrete is being made.

In step 208, a first mix ratio between the local fine aggregate and the import fine aggregate is determined/selected.

In the first Step 210, a local coarse aggregate is selected, for example, naturally occurring rock sourced locally in the region where the concrete is being made.

In step 212, an import coarse aggregate is selected, for example, limestone that is sourced outside of the local region where the concrete is being made.

In step 214, a second mix ratio between the local coarse aggregate and the import coarse aggregate is determined/selected.

In step 216, in accordance with the first mix ratio, the local fine aggregate is mixed with the import fine aggregate to produce the overall composite fine aggregate. Mix ratios may be defined by volume or by weight depending on the desired outcome of the EAF.

With reference to step 218, in accordance with the second mix ratio, the local coarse aggregate is mixed with the import fine aggregate to produce the overall composite fine aggregate. Mix ratios may be defined by volume or by weight depending on the desired outcome of the EAF.

In step 220, a third mix ratio between the overall composite fine aggregate and the overall composite coarse aggregate is determined/selected. Mix ratios may be defined by volume or by weight depending on the desired outcome of the EAF.

With reference to step 222, in accordance with the third mix ratio, the overall composite fine aggregate is mixed with the overall composite coarse aggregate to produce the final concrete mixture. Mix ratios may be defined by volume or by weight depending on the desired outcome of the EAF.

Optionally, in step 224, one or more colors of colored glass may be added to the final concrete mixture or added at earlier points in the process 200 in accordance with the desired outcome of the EAF.

Thereafter, in Step 226, the final concrete mixture is utilized to make concrete. For example, the final concrete mixture is combined with cement admixtures and additives as well as water and allowed to cure. Lastly, in Step 228, the concrete surface is revealed per customary polishing standards producing a unique exposed aggregate finish.

Although the present disclosure and its advantages have been described in detail, it should be understood that various changes, substitutions and alterations can be made herein without departing from the spirit and scope of the disclosure as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

We claim:

1. A process for producing a variation of exposed aggregate finish, the process comprising the steps of:
selecting a local fine aggregate;
selecting an import fine aggregate;
determining a first mix ratio between the local fine aggregate and the import fine aggregate;
selecting a local coarse aggregate;
selecting an import coarse aggregate;
determining a second mix ratio between the local coarse aggregate and the import coarse aggregate;
producing an overall composite fine aggregate by mixing the local fine aggregate with the import fine aggregate in accordance with the first mix ratio;
producing an overall composite coarse aggregate by mixing the local coarse aggregate with the import coarse aggregate in accordance with the second mix ratio; and
producing a final concrete mixture by mixing the overall composite fine aggregate with the overall composite coarse aggregate.

2. The process for producing a variation of exposed aggregate finish as recited in claim 1, further comprising the steps of:
determining a third mix ratio between the overall composite fine aggregate and the overall composite coarse aggregate;
wherein the step of producing a final concrete mixture by mixing the overall composite fine aggregate with the overall composite coarse aggregate is in accordance with the third mix ratio.

3. The process for producing a variation of exposed aggregate finish as recited in claim 2, further comprising the step of:
adding a quantity of at least one color of colored glass to at least one of the overall composite fine aggregate, the overall composite coarse aggregate, or the final concrete mixture.

4. The process for producing a variation of exposed aggregate finish as recited in claim 3, further comprising the step of:
adding a quantity of a second color of colored glass to at least one of the overall composite fine aggregate, the overall composite coarse aggregate, or the final concrete mixture.

5. The process for producing a variation of exposed aggregate finish as recited in claim 4, further comprising the steps of:
producing a cured concrete by utilizing the final concrete mixture; and
producing an exposed aggregate finish of the cured concrete.

6. A process for producing a variation of exposed aggregate finish, the process comprising the steps of:
selecting a local fine aggregate;
selecting an import fine aggregate;
determining a first mix ratio between the local fine aggregate and the import fine aggregate;
selecting a local coarse aggregate;
selecting an import coarse aggregate;
determining a second mix ratio between the local coarse aggregate and the import coarse aggregate;
producing an overall composite fine aggregate by mixing the local fine aggregate with the import fine aggregate in accordance with the first mix ratio;
producing an overall composite coarse aggregate by mixing the local coarse aggregate with the import coarse aggregate in accordance with the second mix ratio;
determining a third mix ratio between the overall composite fine aggregate and the overall composite coarse aggregate;
producing a final concrete mixture by mixing the overall composite fine aggregate with the overall composite coarse aggregate in accordance with the third mix ratio;
producing cured concrete by utilizing the final concrete mixture; and
producing an exposed aggregate finish of the cured concrete.

7. The process for producing a variation of exposed aggregate finish as recited in claim 6, further comprising the step of:
adding a quantity of at least one color of colored glass to at least one of the overall composite fine aggregate, the overall composite coarse aggregate, or the final concrete mixture.

8. The process for producing a variation of exposed aggregate finish as recited in claim 7, further comprising the step of:
adding a quantity of a second color of colored glass to at least one of the overall composite fine aggregate, the overall composite coarse aggregate, or the final concrete mixture.

9. A process for producing a variation of exposed aggregate finish, the process comprising the steps of:
selecting either an import fine aggregate or an import coarse fine aggregate, or both;
selecting a local fine aggregate;
selecting a local coarse aggregate;
if an import fine aggregate was selected, determining a first mix ratio between the local fine aggregate and the import fine aggregate;
if an import coarse aggregate was selected, determining a second mix ratio between the local coarse aggregate and the import coarse aggregate;
if an import fine aggregate was selected, producing an overall composite fine aggregate by mixing the local fine aggregate with the import fine aggregate in accordance with the first mix ratio;
if an import coarse aggregate was selected, producing an overall composite coarse aggregate by mixing the local coarse aggregate with the import coarse aggregate in accordance with the second mix ratio; and
producing a final concrete mixture by mixing the overall composite fine aggregate with the overall composite coarse aggregate.

10. The process for producing a variation of exposed aggregate finish as recited in claim 9, further comprising the steps of:
determining a third mix ratio between the overall composite fine aggregate and the overall composite coarse aggregate;
wherein the step of producing a final concrete mixture by mixing the overall composite fine aggregate with the overall composite coarse aggregate is in accordance with the third mix ratio.

11. The process for producing a variation of exposed aggregate finish as recited in claim 10, further comprising the step of:
adding a quantity of at least one color of colored glass to at least one of the overall composite fine aggregate, the overall composite coarse aggregate, or the final concrete mixture.

12. The process for producing a variation of exposed aggregate finish as recited in claim 11, further comprising the step of:
adding a quantity of a second color of colored glass to at least one of the overall composite fine aggregate, the overall composite coarse aggregate, or the final concrete mixture.
